(19) United States
(12) Patent Application Publication
(10) Pub. No.: US 2002/0103821 A1
(43) Pub. Date: Aug. 1, 2002

(54) System and method for providing a user interface for a deja video system

(75) Inventors: Lira Nikolovska, Eindhoven (NL); Nevenka Dimitrova, Yorktown Heights, NY (US); Yu Chen, New York, NY (US)

Correspondence Address: Corporate Patent Counsel, U.S. Philips Corporation, 580 White Plains Road, Tarrytown, NY, 10591, US

(73) Assignee: PHILIPS ELECTRONICS NORTH AMERICA CORPORATION

(21) Appl. No.: 09/772,319

(22) Filed: Jan. 26, 2001

(51) Int. Cl. G06F 17/00

(52) U.S. Cl. 707/500.1

(57) ABSTRACT

A user interface system is disclosed for use in a video display system that is capable of simultaneously displaying a main multimedia document and a plurality of additional multimedia documents on a display screen. The video display system displays the main multimedia document on a central portion of the display screen. The user interface system receives a user instruction that selects a format for displaying the plurality of additional multimedia documents. The plurality of additional multimedia documents may be displayed in a collage format in which the individual additional multimedia documents are located around the periphery of the main multimedia document. The plurality of additional multimedia documents may also be displayed in one or more horizontal lines or in one or more vertical lines. The user interface system is capable of receiving user instructions to control the display of the plurality of additional multimedia documents.

### TECHNICAL FIELD OF THE INVENTION

The present invention is directed to a system and a method for providing a user interface for a video display system, and more specifically, to a system and method for providing a user interface for a video display system known as “dejaVideo.”

### BACKGROUND OF THE INVENTION

“Deja vu” is the name given to the experience of apparently remembering certain scenes and events when one experiences those scenes and events for the first time. Deja vu is also referred to as “paramnesia.” One explanation for deja vu is that the person who is experiencing deja vu is recalling from memory an experience that is very similar to the person's current experience. The similarity of the remembered experience with respect to the actual experience causes the person to feel that he or she is repeating the earlier experience.

The name “dejaVideo” has been selected to refer to a visual display system that enables a viewer to have access to video segments (or other multimedia documents) based on remembered clues from the video segment that is currently being viewed. In a dejaVideo system, the video segments that are presented to the viewer helps the viewer enhance the experience by letting the viewer explore new content by finding associations with something that the viewer has already seen or heard.

The dejaVideo system can provide more information about the objects seen in the video by providing additional information in either a transparent display mode or an overlay display mode. In a transparent display mode an underlying video image is visible through an overlayed video image. In an overlay display mode an underlying video image is not visible through an overlayed video image. A smooth transition from one scene in a first video clip to a different scene in a second video clip can be performed using visual effects such as image morphing.

The dejaVideo system enables a video segment to be configured to include automatically derived links from video segments or other multimedia documents. A video segment is processed in a video processing system to determine associations between objects, entities, or other features of the video segment and those other documents. Associations are then utilized to access information from those additional documents, so that the accessed information can be displayed with or in place of the original video segment.

The dejaVideo system automatically extracts visual associations using techniques such as frame characterization and object (face) identification. The dejaVideo system accesses for the user (1) a main multimedia document, and (2) additional similar multimedia documents that are visually or conceptually closely related to the main multimedia document. The multimedia documents may include video elements, audio elements, text elements, web sites, or any combination of the above.

There is a need in the art for an improved system and method for providing a user interface for displaying multimedia documents in a dejaVideo system. There is also a need in the art for an improved system and method for enabling a user to selectively access and display multimedia documents in a dejaVideo system.

### SUMMARY OF THE INVENTION

To address the above-discussed deficiencies of the prior art, it is a primary object of the present invention to provide a system and method for providing a user interface for controlling the display of multimedia documents on a dejaVideo video display system.

The present invention comprises a user interface system for a video display system that is capable of simultaneously displaying a main multimedia document and a plurality of additional multimedia documents. The video display system displays the main multimedia document on a central portion of the display screen. The user interface system receives a user instruction that selects a format for displaying the plurality of additional multimedia documents. The plurality of additional multimedia documents are then displayed on the display screen with the format selected by the user.

According to an advantageous embodiment of the present invention, the plurality of additional multimedia documents may be displayed in a collage format in which the individual additional multimedia documents are located around the periphery of the main multimedia document.

According to an advantageous embodiment of the present invention, the plurality of additional multimedia documents may be displayed in a horizontal linear format in which the individual additional multimedia documents are located in one or more horizontal lines on the display screen.

According to another advantageous embodiment of the present invention, the plurality of additional multimedia documents may be displayed in a vertical linear format in which the individual additional multimedia documents are located in one or more vertical lines on the display screen.

According to yet another embodiment of the present invention, the user interface system is capable of receiving user instruction to control the display of the plurality of additional multimedia documents.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a block diagram of an advantageous embodiment of a dejaVideo video display system;

FIG. 2 illustrates an advantageous embodiment of an exemplary dejaVideo video display device;

FIG. 3 illustrates a block diagram of the advantageous embodiment of the exemplary dejaVideo video display device shown in FIG. 2;

FIG. 4 illustrates computer software that may be used to provide the improved user interface of the present invention for a dejaVideo video display system;

FIG. 5 illustrates a display screen of a dejaVideo video display device showing a centrally located main multimedia document and peripherally located smaller multimedia documents arranged in the form of a collage;

FIG. 6 illustrates a display screen of a dejaVideo video display device showing a centrally located main multimedia document and smaller multimedia documents arranged in a horizontal line under the main multimedia document;

FIG. 7 illustrates a display screen of a dejaVideo video display device showing a centrally located main multimedia document and smaller multimedia documents arranged in a vertical line along one edge of the main multimedia document; and

FIG. 8 depicts a flow diagram illustrating the operation of an advantageous embodiment of the method of the present invention.

### DETAILED DESCRIPTION OF THE INVENTION

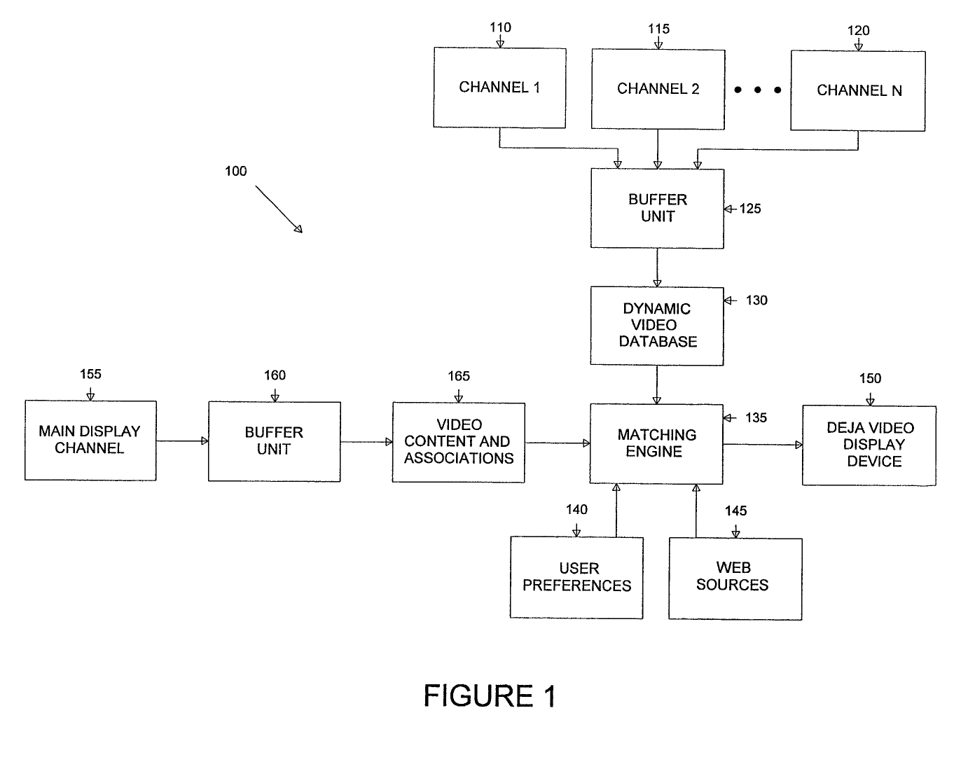

FIGS. 1 through 8, discussed below, and the various embodiments used to describe the principles of the present invention in this patent document are by way of illustration only and should not be construed in any way to limit the scope of the invention. In the description of the exemplary embodiment that follows, the present invention is integrated into, or is used in connection with, a dejaVideo video display system. Those skilled in the art will recognize that the exemplary embodiment of the present invention may easily be modified for use in any type of similar video display system.

A dejaVideo system accesses for the user (1) a main multimedia document, and (2) additional similar multimedia documents that are visually or conceptually closely related to the main multimedia document. The multimedia documents may include video elements, audio elements, text elements, web sites, or any combination of the above.

The similarity between the multimedia documents may be selectively defined at several levels. A low level definition of similarity may focus on individual features such as video elements, audio elements, motion, closed captions, etc. A high level definition of similarity may focus on high level features such as scenes, events, etc.

The two main processes in a dejaVideo system are the authoring process and the navigation (display) process. The authoring process creates associations between video segments (and other types of multimedia documents). During the authoring process interesting features and corresponding association rules are computed for a video sequence for future retrieval purposes. During the navigation process the user gains access to related video segments (and other types of multimedia documents) based on the derived associations. When the dejaVideo system displays the main multimedia document (usually a video segment), it also displays the choices of available hyperlinked multimedia documents based on the main multimedia document and based on different levels of similarities.

FIG. 1 illustrates a block diagram of an advantageous embodiment of a dejaVideo video display system 100. Each of a plurality of channels (110, 115, . . . , 120) that provide video signals (and other multimedia content) are coupled to buffer unit 125. Computed features and association rules for each channel are sent through their respective channels to buffer unit 125. Buffer unit 125 is coupled to dynamic video database 130. The association rules for the channels are transferred to dynamic video database 130. Dynamic video database 130 is coupled to matching engine 135. When a user watches a channel, the association rules of that channel are compared with the rules in dynamic video database 130 using matching engine 135.

User preferences unit 140 and web sources 145 are also coupled to matching engine 135. During the matching process, matching engine 135 accesses user preferences unit 140 to obtain information to take the user's preferences into account. Also during the matching process, matching engine 135 accesses web sources 145 for information from web sites.

Based on the matching results, matching engine 135 obtains hyperlinked documents from the plurality of channels (110, 115, 120) and from web sources 145. The hyperlinked documents are either stored in memory (not shown in FIG. 1) to be viewed later or sent directly to dejaVideo display device 150 to be played simultaneously with the main multimedia document that is being played from main display channel 155.

Main display channel 155 is the source of the main multimedia document. Main display channel 155 is coupled to buffer unit 160, which is coupled to video content and associations unit 165. Video content and associations unit 165 is coupled to matching engine 135.

In the embodiment shown in FIG. 1, the main multimedia document is received in matching engine 135 from main display channel 155 (via buffer unit 160 and video content and associations unit 165). The additional similar multimedia documents are received in matching engine 135 from the plurality of channels (110, 115, . . . , 120) (via buffer unit 125 and dynamic video database 130) and from web sources 145. A tuner circuit (not shown) may be used to select one desired channel (from a number of different available channels) to occupy the position of main display channel 155.

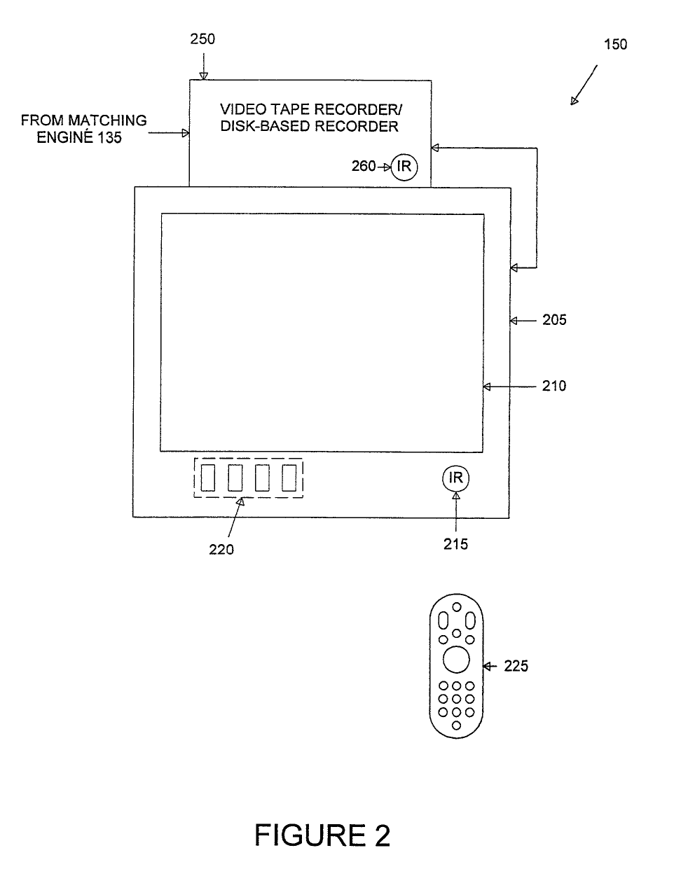

FIG. 2 illustrates an exemplary dejaVideo display device 150. In one advantageous embodiment of the present invention, dejaVideo display device 150 comprises video recorder 250 and television set 205. Video recorder 250 receives incoming multimedia signals from matching engine 135. Video recorder 250 transmits multimedia signals to television set 205 for display.

In Record mode, video recorder 250 may demodulate an incoming radio frequency (RF) television signal to produce a baseband video signal that is recorded and stored on a storage medium within or connected to video recorder 250. In Play mode, video recorder 250 reads a stored baseband video signal (i.e., a program) selected by the viewer from the storage medium and transmits it to television set 205. Video recorder 250 may also comprise a video recorder of the type that is capable of receiving, recording, interacting with, and playing digital signals.

Video recorder 250 may comprise a video recorder of the type that utilizes recording tape, or that utilizes a hard disk, or that utilizes solid state memory, or that utilizes any other type of recording apparatus. If video recorder 250 is a video cassette recorder (VCR), video recorder 250 stores and retrieves the incoming multimedia signals to and from a magnetic cassette tape. If video recorder 250 is a disk drive-based device, such as a ReplayTV™ recorder or a TiVO™ recorder, video recorder 250 stores and retrieves the incoming multimedia signals to and from a computer magnetic hard disk rather than a magnetic cassette tape. In still other embodiments, video recorder 250 may store and retrieve from a local read/write (R/W) digital versatile disk (DVD-RW) or a read/write (R/W) compact disk (CD-RW). The local storage medium may be fixed (e.g., hard disk drive) or may be removable (e.g., DVD-RW, CD-RW).

Video recorder 250 comprises infrared (IR) sensor 260 that receives commands (such as Channel Up, Channel Down, Volume Up, Volume Down, Record, Play, Fast Forward (FF), Reverse, and the like) from remote control device 225 operated by the viewer. Television set 205 is a conventional television comprising screen 210, infrared (IR) sensor 215, and one or more manual controls 220 (indicated by a dotted line). IR sensor 215 also receives commands (such as Volume Up, Volume Down, Power On, Power Off) from remote control device 225 operated by the viewer.

It should be noted that video recorder 250 is not limited to receiving a particular type of incoming multimedia signal. The incoming signal may be a digital signal, an analog signal, Internet protocol (IP) packets, or signals in other types of format.

For the purposes of simplicity and clarity in explaining the principles of the present invention, the descriptions that follow shall generally be directed to an embodiment in which video recorder 250 receives incoming analog multimedia signals that contain closed caption text information. Nonetheless, those skilled in the art will understand that the principles of the present invention may readily be adapted for use with digital television signals, wireless broadcast television signals, local storage systems, an incoming stream of IP packets containing MPEG data, and the like.

In addition, those skilled in the art will understand that the principles of the present invention may readily be adapted for use with other sources of text, including, but not limited to, text from a speech to text converter, text from a third party source, text from extracted video text, text from embedded screen text, and the like. Therefore, the term “transcript” shall be defined to mean a text file originating from any source of text, including, but not limited to, closed caption text, text from a speech to text converter, text from a third party source, text from extracted video text, text from embedded screen text, and the like.

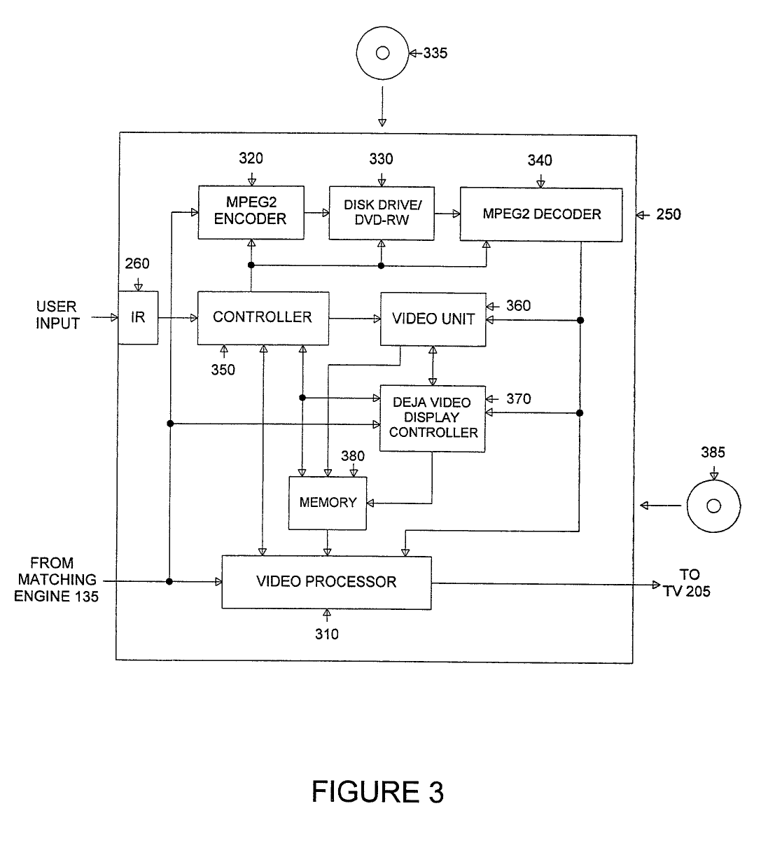

FIG. 3 illustrates exemplary video recorder 250 in greater detail according to one embodiment of the present invention. Video recorder 250 comprises IR sensor 260, video processor 310, MPEG2 encoder 320, hard disk drive 330, MPEG2 decoder 340, and controller 350. Video recorder 250 further comprises video unit 360, dejaVideo display controller 370, and memory 380. Controller 350 directs the overall operation of video recorder 250, including View mode, Record mode, Play mode, Fast Forward (FF) mode, Reverse mode, and other similar functions. Controller 350 also directs the creation, display and interaction of multimedia documents in accordance with the principles of the present invention.

In View mode, controller 350 causes the incoming multimedia signal from matching engine 135 to be demodulated and processed by video processor 310 and transmitted to television set 205, with or without storing video signals on (or retrieving video signals from) hard disk drive 330. Video processor 310 contains radio frequency (RF) front-end circuitry for receiving incoming multimedia signals from matching engine 135, and converting the multimedia signals to baseband television signals (e.g., super video signal) suitable for display on television set 205. Video processor 310 also is capable of receiving a conventional signal from MPEG2 decoder 340 and video frames from memory 380 and transmitting a baseband television signal (e.g., super video signal) to television set 205.

In Record mode, controller 350 causes the incoming multimedia signal to be stored on hard disk drive 330. Under the control of controller 350, MPEG2 encoder 320 receives an incoming analog multimedia signal from matching engine 135 and converts the received multimedia signal to MPEG format for storage on hard disk drive 330. Note that in the case of a digital multimedia signal, the signal may be stored directly on hard disk drive 330 without being encoded in MPEG2 encoder 320.

In Play mode, controller 350 directs hard disk drive 330 to stream the stored multimedia signal (i.e., a program) to MPEG2 decoder 340, which converts the MPEG2 data from hard disk drive 330 to, for example, a super video (S-Video) signal that video processor 310 transmits to television set 205.

It should be noted that the choice of the MPEG2 standard for MPEG2 encoder 320 and MPEG2 decoder 340 is by way of illustration only. In alternate embodiments of the present invention, the MPEG encoder and decoder may comply with one or more of the MPEG-1, MPEG-2, and MPEG-4 standards, or with one or more other types of standards.

For the purposes of this application and the claims that follow, hard disk drive 330 is defined to include any mass storage device that is both readable and writable, including, but not limited to, conventional magnetic disk drives and optical disk drives for read/write digital versatile disks (DVD-RW), re-writable CD-ROMs, VCR tapes and the like. In fact, hard disk drive 330 need not be fixed in the conventional sense that it is permanently embedded in video recorder 250. Rather, hard disk drive 330 includes any mass storage device that is dedicated to video recorder 250 for the purpose of storing recorded video programs. Thus, hard disk drive 330 may include an attached peripheral drive or removable disk drives (whether embedded or attached), such as a juke box device (not shown) that holds several read/write DVDs or re-writable CD-ROMs. As illustrated schematically in FIG. 3, removable disk drives of this type are capable of receiving and reading re-writable CD-ROM disk 335.

Furthermore, in an advantageous embodiment of the present invention, hard disk drive 330 may include external mass storage devices that video recorder 250 may access and control via a network connection (e.g., Internet protocol (IP) connection), including, for example, a disk drive in the viewer's home personal computer (PC) or a disk drive on a server at the viewer's Internet service provider (ISP).

Controller 350 obtains information from video processor 310 concerning video signals that are received by video processor 310. When controller 350 determines that video recorder 250 is receiving a video program, controller 350 determines if the video program is one that has been selected to be recorded. If the video program is to be recorded, then controller 350 causes the video program to be recorded on hard disk drive 330 in the manner previously described. If the video program is not to be recorded, then controller 350 causes the video program to be processed by video processor 310 and transmitted to television set 205 in the manner previously described.

Memory 380 may comprise random access memory (RAM) or a combination of random access memory (RAM) and read only memory (ROM). Memory 380 may comprise a non-volatile random access memory (RAM), such as flash memory. In an alternate advantageous embodiment of television receiver 205, memory 380 may comprise a mass storage data device, such as a hard disk drive (not shown). Memory 380 may also include an attached peripheral drive or removable disk drives (whether embedded or attached) that reads read/write DVDs or re-writable CD-ROMs. As illustrated schematically in FIG. 3, removable disk drives of this type are capable of receiving and reading re-writable CD-ROM disk 385.

The main multimedia document is centrally displayed on display screen 210. To coordinate the simultaneous display of the additional multimedia documents on display screen 210 controller 350 uses video unit 360. Video unit 360 formats the placement of the additional multimedia documents. As will be more fully described, video unit 360 locates each additional multimedia document on display screen 210 in accordance with instructions from dejaVideo display controller 370.

Video unit 360 uses the method and apparatus for linking video segments that is set forth and described in U.S. patent application Ser. No. 09/351,086 filed Jul. 9, 1999, entitled “METHOD AND APPARATUS FOR LINKING A VIDEO SEGMENT TO ANOTHER SEGMENT OR INFORMATION SOURCE.” Additional multimedia documents may display different types of information. For example, an additional multimedia document may display a pointer or a link to another document location (e.g., a universal resource locator or “URL”). An additional multimedia document may display all of a video document. Alternatively, an additional multimedia document may display a portion (or “thumbnail”) of a larger video document. An additional multimedia document may also display a summary of a video document (e.g., the title of a motion picture and a few video images from the movie).

DejaVideo display controller 370 receives user instructions from user input 260 (via controller 350). In response to the user instructions, dejaVideo display controller 370 then provides controller 350 and video unit 360 with a user selected display format for the additional multimedia documents.

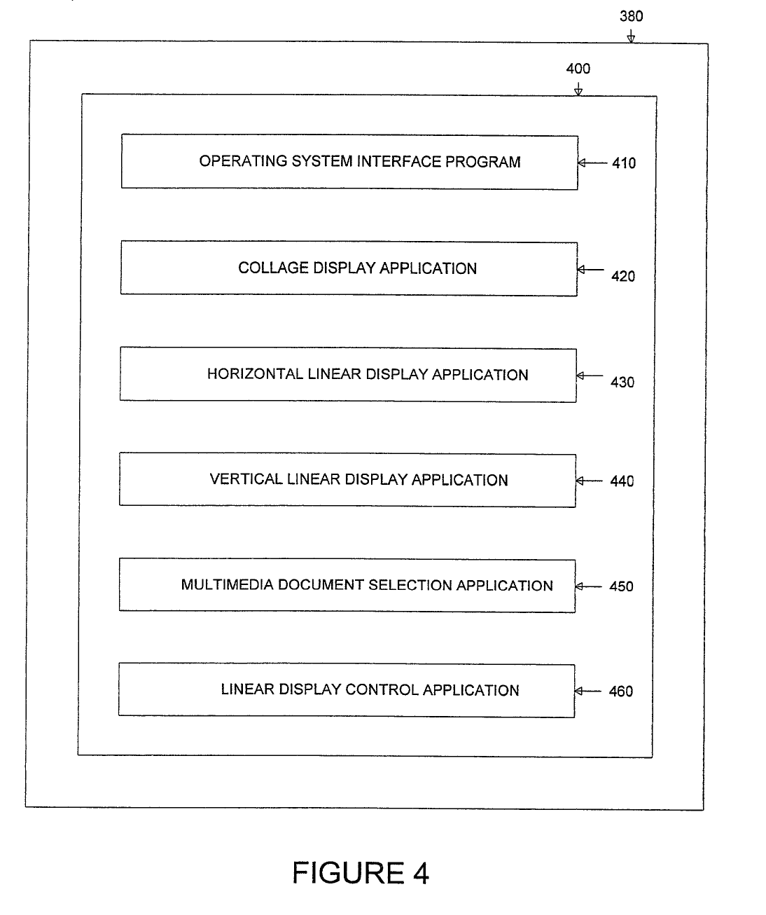

An advantageous embodiment of the present invention comprises computer software 400 capable of providing a user interface for dejaVideo system 100. In particular, computer software 400 is capable of providing one or more user selected formats for displaying additional multimedia documents on display screen 210. FIG. 4 illustrates a selected portion of memory 380 that contains computer software 400 of the present invention. Memory 380 contains operating system interface program 410, collage display application 420, horizontal linear display application 430, vertical linear display application 440, multimedia document selection application 450, and linear display control application 460.

DejaVideo display controller 370 and computer software 400 together comprise a user interface controller that is capable of carrying out the present invention. Operating system interface program 410 coordinates the operation of computer software 400 with the operating system of controller 350.

DejaVideo display controller 370 receives user instructions from user input 260 (via controller 350). The user may instruct dejaVideo display controller 370 to arrange the additional multimedia documents around the main multimedia document in a collage format. In response to this type of user request, dejaVideo display controller 370 accesses collage display application 420 in software 400 stored within memory 380. Collage display application 420 causes the additional multimedia documents to be located around the periphery of the main multimedia document displayed on display screen 210.

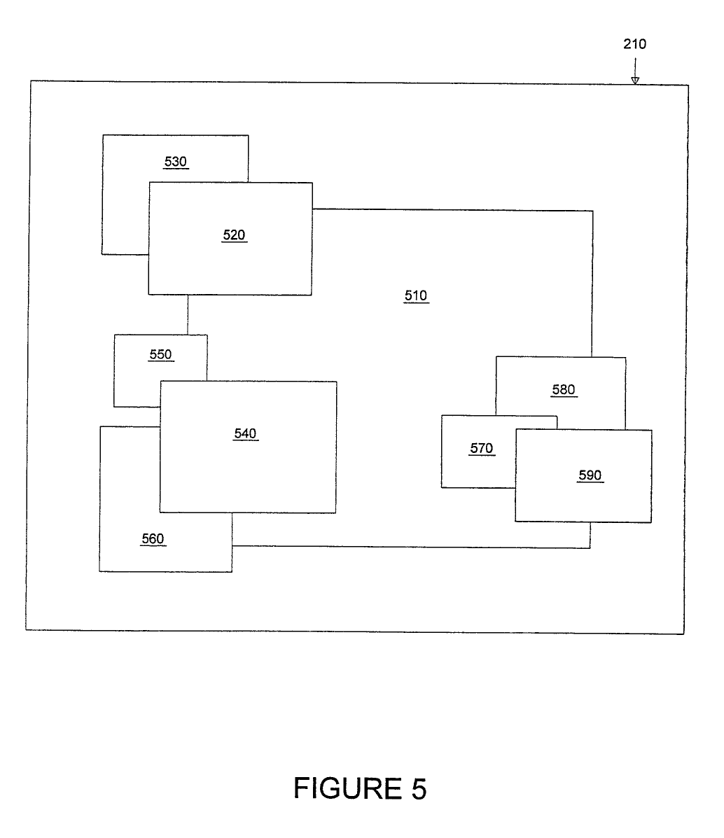

This may be more clearly seen with reference to FIG. 5. FIG. 5 shows main multimedia document 510 displayed on display screen 210. Additional multimedia documents, 520, 530, 540, 550, 560, 570, 580, and 590, are located around the periphery of main multimedia document 510. This format is referred to as the “collage” format. In the “collage” format, the individual multimedia documents may be displayed so that they partially cover or “overlap” each other. The individual multimedia documents may also partially cover or “overlap” main multimedia document 510.

If the user desires to cause one of the additional multimedia documents (for example, document 560) to be displayed as the main multimedia document 510, then the user sends an instruction to dejaVideo display controller 370 via user input 260 and controller 350. In response to the instruction, dejaVideo display controller 370 accesses multimedia document selection application 450 in software 400 stored within memory 380. Multimedia document selection application 450 causes the selected additional multimedia document (document 560 in this example) to be displayed as main multimedia document 510. The multimedia document that was previously displayed as main multimedia document 510 is then displayed as the new document 560.

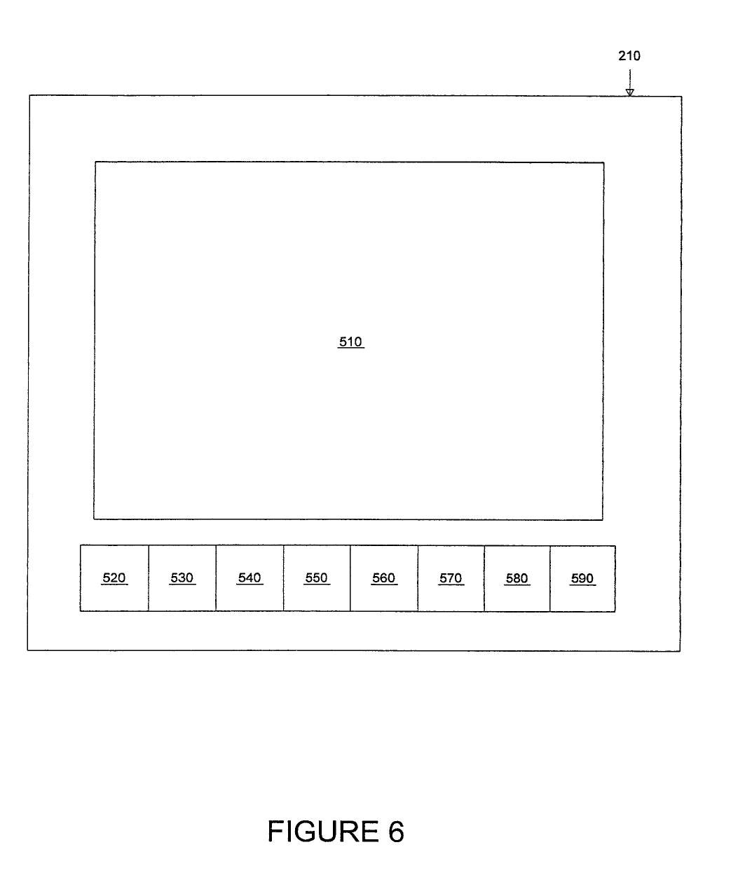

The user may also instruct dejaVideo display controller 370 to arrange the additional multimedia documents beneath main multimedia document 510 in a horizontal linear format. In response to this type of user request, dejaVideo display controller 370 accesses horizontal linear display application 430 in software 400 stored within memory 380. Horizontal linear display application 430 causes the additional multimedia documents to be displayed on display screen 210 beneath main multimedia document 510 as shown in FIG. 6.

FIG. 6 shows main multimedia document 510 displayed on display screen 210. Additional multimedia documents, 520, 530, 540, 550, 560, 570, 580, and 590, are displayed in a horizontal line beneath main multimedia document 510. This format is referred to as the “horizontal linear” format. In the “horizontal linear” format, the individual multimedia documents are displayed so that they do not partially cover or “overlap” each other or main multimedia document 510.

As will be more fully explained, the system and method of the present invention is capable of moving the display of the additional multimedia documents, 520 through 590, either left or right within the horizontal line beneath main multimedia document 510 on display screen 210.

As in the case of the “collage” format, if the user desires to cause one of the additional multimedia documents in the “horizontal linear” format (for example, document 530) to be displayed as the main multimedia document 510, then the user sends an instruction to dejaVideo display controller 370 via user input 260 and controller 350. In response to the instruction, dejaVideo display controller 370 accesses multimedia document selection application 450 in software 400 stored within memory 380. Multimedia document selection application 450 causes the selected additional multimedia document (document 530 in this example) to be displayed as main multimedia document 510. The multimedia document that was previously displayed as main multimedia document 510 is then displayed as the new document 530.

The user may also instruct dejaVideo display controller 370 to arrange the additional multimedia documents along one or both of the two vertical edges of main multimedia document 510. This format is referred to as the “vertical linear” format. In the “vertical linear” format, the individual multimedia documents are displayed so that they do not partially cover or “overlap” each other or main multimedia document 510.

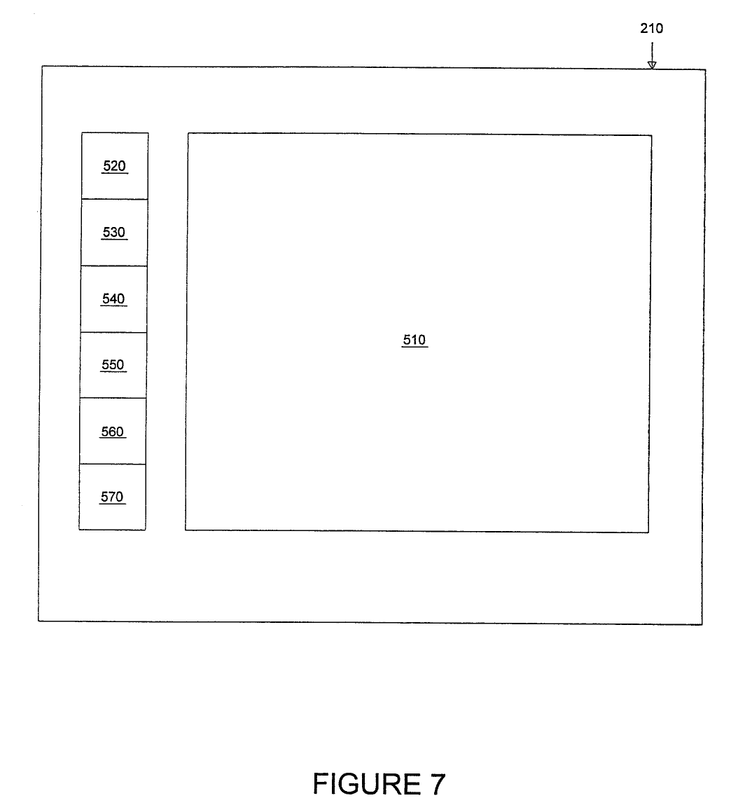

In response to this type of user request, dejaVideo display controller 370 accesses vertical linear display application 440 in software 400 stored within memory 380. Vertical linear display application 440 causes the additional multimedia documents to be displayed on display screen 210 along one or both of the two vertical edges of main multimedia document 510 as shown in FIG. 7.

As will be more fully explained, the system and method of the present invention is capable of moving the display of the additional multimedia documents, 520 through 570, either up or down within a vertical line located beside main multimedia document 510 on display screen 210.

As in the case of the “collage” format and the “horizontal linear” format, the user may cause one of the additional multimedia documents in the “vertical linear” format to be displayed as main multimedia document 510. This may be accomplished by using multimedia document selection application 450 in the manner previously described.

There may be instances where the number of additional multimedia documents exceeds the number of positions available to display them all simultaneously in a “horizontal linear” format or a “vertical linear” format. For example, in the “horizontal linear” format shown in FIG. 6, there are positions for eight additional multimedia documents to be simultaneously displayed beneath main multimedia document 510. When there are more than eight additional multimedia documents to be displayed, the user may send an instruction to cause all of the additional multimedia documents to be sequentially displayed within the eight position “window” of the “horizontal linear” format. The user may send such an instruction to dejaVideo display controller 370 via user input 260 and controller 350.

In response to the instruction, dejaVideo display controller 370 accesses linear display control application 460 in software 400 stored within memory 380. In one advantageous embodiment of the present invention, linear display control application 460 then causes multimedia document 520 to cease to be displayed, then causes multimedia document 530 to be displayed in the location previously occupied by multimedia document 520. This process is repeated for each of the multimedia documents until multimedia document 590 is displayed in the location previously occupied by multimedia document 580. Then the ninth multimedia document (not shown) is displayed in the location previously occupied by multimedia document 590.

The process of sequentially moving the multimedia documents may be repeated for each additional multimedia document so that the multimedia documents appear to move from right to left through the eight position “window” of the “horizontal linear” format. The direction of movement in the process may also be chosen to be from left to right. When the last of the multimedia documents has moved from the position initially occupied by document 590 to the position initially occupied by document 580, then document 520 is displayed in the position initially occupied by document 590. In this manner, a complete cycle of the multimedia documents is formed and sequentially displayed eight documents at a time. Of course, the number eight is for this example only. A different number may be used depending upon the size of the multimedia documents displayed on display screen 210.

The process of sequentially moving the multimedia documents may also be used with the “vertical linear” format so that the multimedia documents appear to move from top to bottom (or from bottom to top) through the positions in the “vertical linear” format “window.”

While the multimedia documents are being sequentially displayed in the manner described above, the user may send an instruction to cause the sequential movement of the display of the multimedia documents to halt. The user may send such an instruction to dejaVideo display controller 370 via user input 260 and controller 350.

In response to an instruction to halt the sequential movement of the display, dejaVideo display controller 370 accesses linear display control application 460 in software 400 stored within memory 380. Linear display control application 460 then causes the sequential movement of the display of the multimedia documents to halt until a user instruction is received to cause the sequential movement of the display of the multimedia documents to be resumed.

Similarly, while the multimedia documents are being sequentially displayed in the manner described above, the user may send an instruction to cause the sequential movement of the display of the multimedia documents to reverse direction. The user may send such an instruction to dejaVideo display controller 370 via user input 260 and controller 350.

In response to an instruction to reverse the direction of the sequential movement of the display, dejaVideo display controller 370 accesses linear display control application 460 in software 400 stored within memory 380. Linear display control application 460 then causes the sequential movement of the display of the multimedia documents to reverse direction until a user instruction is received to cause the sequential movement of the display of the multimedia documents to resume its original direction.

In addition, while the multimedia documents are being sequentially displayed in the manner described above, the user may send an instruction to control the speed of the sequential movement of the display. The reading ability and reading speed of viewers varies from person to person. The speed control feature enables a viewer to adjust the speed of movement of the display so that the viewer will have sufficient time to read and react to the display of the multimedia documents.

In response to an instruction to increase or decrease the speed of the sequential movement of the display, dejaVideo display controller 370 accesses linear display control application 460 in software 400 stored within memory 380. Linear display control application 460 then causes the speed of the sequential movement of the display of the multimedia documents to increase or decrease in accordance with the instruction provided by the user.

At any time while the multimedia documents are being sequentially displayed, the user can cause any one of the sequentially displayed multimedia documents to be selected to be displayed in the position of main multimedia document 510. This is accomplished using multimedia document selection application 450 as previously described.

In another advantageous embodiment of the user interface of the present invention, more than one “horizontal linear” format line may be shown simultaneously. Similarly, more than one “vertical linear” format line may be shown simultaneously. In yet another advantageous embodiment of the user interface of the present invention, one or more “horizontal linear” format lines and one or more “vertical linear” format lines may be shown simultaneously.

When at least two “horizontal linear” format lines are shown simultaneously, one of the “horizontal linear” format lines can display multimedia documents that relate to associations for the image composition of the main multimedia document, and one of the “horizontal linear” format lines can display multimedia documents that relate to associations for object identification with faces. Alternatively, each of the “horizontal linear” format lines can display multimedia documents that relate to associations based on a specific user profile.

The same principles apply to the case where at least two “vertical linear” format lines are shown simultaneously. The same principles apply to the case where at least one “horizontal linear” format line and at least one “vertical linear” format line are shown simultaneously.

In an alternate advantageous embodiment of the present invention, the multimedia documents may be displayed so that they may be made to appear and disappear on display screen 210. For example, assume that the available space on display screen 210 is already full of multimedia documents. When another multimedia document is to be added to display screen 210, one of the “old” multimedia documents on display screen 210 disappears and the “new” multimedia document appears in its place. This process may be repeated as necessary to display any number of multimedia documents.

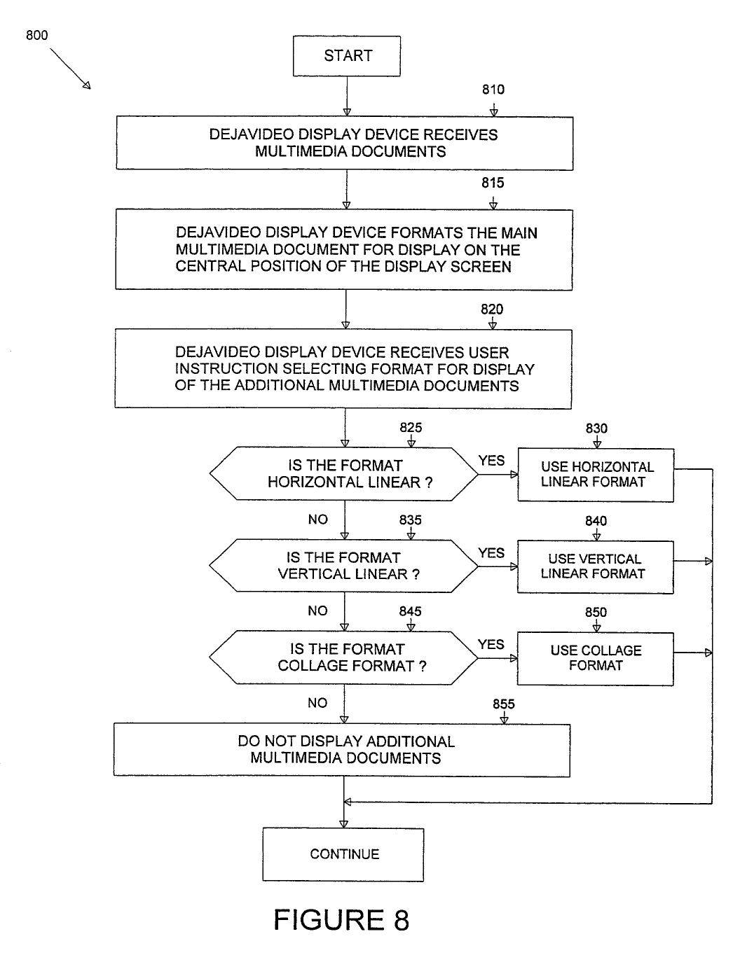

FIG. 8 depicts flow diagram 800 illustrating the operation of an advantageous embodiment of the method of the present invention. The steps set forth in flow diagram 800 are executed in dejaVideo display device 150 and, more particularly, in the user interface controller that comprises dejaVideo display controller 370 and computer software 400.

DejaVideo display device 150 receives the main multimedia document and the additional multimedia documents from matching engine 135 (step 810). DejaVideo display device 150 then formats the main multimedia document for display on the central portion of display screen 210 (step 815).

DejaVideo display device 150 receives a user instruction that selects the format for displaying the additional multimedia documents (step 820). Then dejaVideo display device 150 makes a determination whether the user instruction has requested the “horizontal linear” format to be used (decision step 825). If the user instruction has requested the “horizontal linear” format, then dejaVideo display device 150 uses that format to format the additional multimedia documents for display (step 830).

If the user instruction has not requested the “horizontal linear” format, then dejaVideo display device 150 makes a determination whether the user instruction has requested the “vertical linear” format to be used (decision step 835). If the user instruction has requested the “vertical linear” format, then dejaVideo display device 150 uses that format to format the additional multimedia documents for display (step 840).

If the user instruction has not requested the “vertical linear” format, then dejaVideo display device 150 makes a determination whether the user instruction has requested the “collage” format to be used (decision step 845). If the user instruction has requested the “collage” format, then dejaVideo display device 150 uses that format to format the additional multimedia documents for display (step 850).

If the user instruction has not requested the “collage” format, then dejaVideo display device 150 will not display the additional multimedia documents (step 855) until dejaVideo display device 150 receives a user instruction with a valid format request.

Although the present invention has been described in detail, those skilled in the art should understand that they can make various changes, substitutions and alterations herein without departing from the spirit and scope of the invention in its broadest form.

What is claimed is:

1. For use in a video display system capable of simultaneously displaying a main multimedia document and a plurality of additional multimedia documents on a display screen, a user interface system for said video display system, said user interface system comprising:
a user interface controller capable of receiving at least one instruction from a user that selects a format for displaying said plurality of additional multimedia documents with said main multimedia document,
wherein said user interface controller is capable of displaying said plurality of additional multimedia documents on said display screen in the format selected by said user.

2. The user interface system as claimed in claim 1 wherein said format for displaying said plurality of additional multimedia documents with said main multimedia document comprises one of: a horizontal linear format, a vertical linear format, and a collage format.

3. The user interface system as claimed in claim 1 wherein said format for displaying said plurality of additional multimedia documents with said main multimedia document comprises at least one horizontal linear format.

4. The user interface system as claimed in claim 3 wherein said format for displaying said plurality of additional multimedia documents with said main multimedia document further comprises at least one vertical linear format.

5. The user interface system as claimed in claim 1 wherein said user interface controller is capable of receiving at least one instruction from a user that selects one of said plurality of additional multimedia documents to be displayed as a main multimedia document, and wherein said user interface controller is capable of displaying said selected one of said plurality of said additional multimedia documents on said display screen as a main multimedia document.

6. The user interface system as claimed in claim 1 wherein in response to receiving a user instruction, said user interface controller is capable of displaying said plurality of additional multimedia documents on said display screen in a horizontal linear format, and
wherein in response to receiving a user instruction, said user interface controller is capable of sequentially moving said plurality of said additional multimedia documents on said display screen within said horizontal linear format.

7. The user interface system as claimed in claim 6 wherein in response to receiving a user instruction, said user interface controller is capable of reversing the direction of the sequential movement of said plurality of said additional multimedia documents on said display screen within said horizontal linear format, and
wherein in response to receiving a user instruction, said user interface controller is capable of controlling the speed of movement of said plurality of said additional multimedia documents on said display screen within said horizontal linear format.

8. The user interface system as claimed in claim 1 wherein in response to receiving a user instruction, said user interface controller is capable of displaying said plurality of additional multimedia documents on said display screen in a vertical linear format, and
wherein in response to receiving a user instruction, said user interface controller is capable of sequentially moving said plurality of said additional multimedia documents on said display screen within said vertical linear format.

9. The user interface system as claimed in claim 8 wherein in response to receiving a user instruction, said user interface controller is capable of reversing the direction of the sequential movement of said plurality of said additional multimedia documents on said display screen within said vertical linear format, and
wherein in response to receiving a user instruction, said user interface controller is capable of controlling the speed of movement of said plurality of said additional multimedia documents on said display screen within said vertical linear format.

10. The user interface system as claimed in claim 1 wherein said user interface controller comprises:
a dejaVideo display controller capable of executing computer software instructions contained within a memory coupled to said dejaVideo display controller to receive at least one instruction from a user that selects a format for displaying said plurality of additional multimedia documents with said main multimedia document, and to display said plurality of additional multimedia documents on said display screen in the format selected by said user.

11. The user interface system as claimed in claim 1 wherein said plurality of multimedia documents comprises at least one of: a multimedia document containing a link to another document location, a multimedia document containing all of a video document, a multimedia document containing a portion of a larger video document, and a multimedia document that contains a summary of a video document.

12. The user interface system as claimed in claim 1 wherein said user interface controller is capable of displaying said plurality of additional multimedia documents on said display screen to cause individual multimedia documents to appear and disappear on said display screen.

13. The user interface system as claimed in claim 10 wherein said dejaVideo display controller is capable of executing:
a collage display application capable of displaying said plurality of additional multimedia documents with said main multimedia document in a collage format;
a horizontal linear display application capable of displaying said plurality of additional multimedia documents with said main multimedia document in a horizontal linear format;
a vertical linear display application capable of displaying said plurality of additional multimedia documents with said main multimedia document in a vertical linear format;
a multimedia document selection application capable of displaying a selected one of said plurality of additional multimedia documents as a main multimedia document; and
a linear display control application capable of receiving at least one user instruction for controlling the display of said additional multimedia documents in said horizontal linear format and in said vertical linear format.

14. A video display system capable of simultaneously displaying a main multimedia document and a plurality of additional multimedia documents on a display screen, said video display system comprising a user interface system comprising:
a user interface controller capable of receiving at least one instruction from a user that selects a format for displaying said plurality of additional multimedia documents with said main multimedia document,
wherein said user interface controller is capable of displaying said plurality of additional multimedia documents on said display screen in the format selected by said user.

15. The video display system as claimed in claim 14 wherein said format for displaying said plurality of additional multimedia documents with said main multimedia document comprises one of: a horizontal linear format, a vertical linear format, and a collage format.

16. The video display system as claimed in claim 14 wherein said format for displaying said plurality of additional multimedia documents with said main multimedia document comprises at least one horizontal linear format.

17. The video display system as claimed in claim 16 wherein said format for displaying said plurality of additional multimedia documents with said main multimedia document further comprises at least one vertical linear format.

18. The video display system as claimed in claim 14 wherein said user interface controller is capable of receiving at least one instruction from a user that selects one of said plurality of additional multimedia documents to be displayed as a main multimedia document, and wherein said user interface controller is capable of displaying said selected one of said plurality of said additional multimedia documents on said display screen as a main multimedia document.

19. The video display system as claimed in claim 14 wherein in response to receiving a user instruction, said user interface controller is capable of displaying said plurality of additional multimedia documents on said display screen in a horizontal linear format, and
wherein in response to receiving a user instruction, said user interface controller is capable of sequentially moving said plurality of said additional multimedia documents on said display screen within said horizontal linear format.

20. The video display system as claimed in claim 19 wherein in response to receiving a user instruction, said user interface controller is capable of reversing the direction of the sequential movement of said plurality of said additional multimedia documents on said display screen within said horizontal linear format, and
wherein in response to receiving a user instruction, said user interface controller is capable of controlling the speed of movement of said plurality of said additional multimedia documents on said display screen within said horizontal linear format.

21. The video display system as claimed in claim 14 wherein in response to receiving a user instruction, said user interface controller is capable of displaying said plurality of additional multimedia documents on said display screen in a vertical linear format, and
wherein in response to receiving a user instruction, said user interface controller is capable of sequentially moving said plurality of said additional multimedia documents on said display screen within said vertical linear format.

22. The video display system as claimed in claim 21 wherein in response to receiving a user instruction, said user interface controller is capable of reversing the direction of the sequential movement of said plurality of said additional multimedia documents on said display screen within said vertical linear format, and
wherein in response to receiving a user instruction, said user interface controller is capable of controlling the speed of movement of said plurality of said additional multimedia documents on said display screen within said vertical linear format.

23. The video display system as claimed in claim 14 wherein said user interface controller comprises:
a dejaVideo display controller capable of executing computer software instructions contained within a memory coupled to said dejaVideo display controller to receive at least one instruction from a user that selects a format for displaying said plurality of additional multimedia documents with said main multimedia document, and to display said plurality of additional multimedia documents on said display screen in the format selected by said user.

24. The video display system as claimed in claim 14 wherein said plurality of multimedia documents comprises at least one of: a multimedia document containing a link to another document location, a multimedia document containing all of a video document, a multimedia document containing a portion of a larger video document, and a multimedia document that contains a summary of a video document.

25. The video display system as claimed in claim 14 wherein said user interface controller is capable of displaying said plurality of additional multimedia documents on said display screen to cause individual multimedia documents to appear and disappear on said display screen.

26. The video display system as claimed in claim 23 wherein said dejaVideo display controller is capable of executing:
a collage display application capable of displaying said plurality of additional multimedia documents with said main multimedia document in a collage format;
a horizontal linear display application capable of displaying said plurality of additional multimedia documents with said main multimedia document in a horizontal linear format;
a vertical linear display application capable of displaying said plurality of additional multimedia documents with said main multimedia document in a vertical linear format;
a multimedia document selection application capable of displaying a selected one of said plurality of additional multimedia documents as a main multimedia document; and
a linear display control application capable of receiving at least one user instruction for controlling the display of said additional multimedia documents in said horizontal linear format and in said vertical linear format.

27. For use in a video display system capable of simultaneously displaying a main multimedia document and a plurality of additional multimedia documents on a display screen, a method for providing a user interface for said video display system, said method comprising the steps of:
receiving at least one instruction from a user in a user interface controller that selects a format for displaying said plurality of additional multimedia documents with said main multimedia document; and
displaying said plurality of additional multimedia documents on said display screen in the format selected by said user.

28. The method as claimed in claim 27 wherein said format for displaying said plurality of additional multimedia documents with said main multimedia document comprises one of: a horizontal linear format, a vertical linear format, and a collage format.

29. The method as claimed in claim 27 wherein said format for displaying said plurality of additional multimedia documents with said main multimedia document comprises at least one horizontal linear format.

30. The method as claimed in claim 29 wherein said format for displaying said plurality of additional multimedia documents with said main multimedia document comprises at least one vertical linear format.

31. The method as claimed in claim 27 further comprising the steps of:
receiving at least one instruction from a user in a user interface controller that selects one of said plurality of additional multimedia documents to be displayed as a main multimedia document; and
displaying said selected one of said plurality of said additional multimedia documents on said display screen as a main multimedia document.

32. The method as claimed in claim 27 further comprising the steps of:
receiving a user instruction to display said plurality of multimedia documents on said display screen in horizontal linear format;
displaying said plurality of multimedia documents on said display screen in said horizontal linear format;
receiving a user instruction to sequentially move said plurality of said additional multimedia documents on said display screen within said horizontal linear format; and
sequentially moving said plurality of said additional multimedia documents on said display screen within said horizontal linear format.

33. The method as claimed in claim 27 further comprising the steps of:
receiving a user instruction to display said plurality of multimedia documents on said display screen in vertical linear format;
displaying said plurality of multimedia documents on said display screen in said vertical linear format;
receiving a user instruction to sequentially move said plurality of said additional multimedia documents on said display screen within said vertical linear format; and
sequentially moving said plurality of said additional multimedia documents on said display screen within said vertical linear format.

34. The method as claimed in claim 27 further comprising the steps of:
executing a collage display application in a dejaVideo display controller to display said plurality of additional multimedia documents with said main multimedia document in a collage format when a user instruction is received that requests said collage format;
executing a horizontal linear display application in a dejaVideo display controller to display said plurality of additional multimedia documents with said main multimedia document in a horizontal linear format when a user instruction is received that requests said horizontal linear format; and
executing a vertical linear display application in a dejaVideo display controller to display said plurality of additional multimedia documents with said main multimedia document in a vertical linear format when a user instruction is received that requests said vertical linear format.

35. The method as claimed in claim 27 further comprising the steps of:
receiving in a dejaVideo display controller a main multimedia document and a plurality of additional multimedia documents;
displaying said main multimedia document on a central portion of said display screen;
receiving a user instruction that selects a format for displaying said plurality of additional multimedia documents;
displaying said plurality of additional multimedia documents with said main multimedia document in a collage format when said user instruction requests said collage format;
displaying said plurality of additional multimedia documents with said main multimedia document in a horizontal linear format when said user instruction requests said horizontal linear format; and
displaying said plurality of additional multimedia documents with said main multimedia document in a vertical linear format when said user instruction requests said vertical linear format.

36. The method as claimed in claim 32 further comprising the step of:
controlling the speed of movement of said plurality of said multimedia documents on said display screen within said horizontal linear format.

37. The method as claimed in claim 33 further comprising the step of:
controlling the speed of movement of said plurality of said multimedia documents on said display screen within said vertical linear format.

38. The method as claimed in claim 27 further comprising the step of:
displaying said plurality of additional multimedia documents on said display screen to cause individual multimedia documents to appear and disappear on said display screen.
